(19) United States
(12) Patent Application Publication
(10) Pub. No.: US 2007/0259256 A1
(43) Pub. Date: Nov. 8, 2007

(54) Systems and methods for detecting and indicating fault conditions in electrochemical cells

(76) Inventors: Jean-Marc Le Canut, Mississauga (CA); Rami Michel Abouatallah, Toronto (CA)

Correspondence Address: BERESKIN AND PARR, 40 KING STREET WEST, BOX 401, TORONTO, ON, M5H 3Y2, CA

(21) Appl. No.: 11/288,150

(22) Filed: Nov. 29, 2005

Related U.S. Application Data
(60) Provisional application No. 60/631,232, filed on Nov. 29, 2004.
(60) Provisional application No. 60/679,663, filed on May 11, 2005.

(51) Int. Cl. G05F 1/00; H01M 10/48

(52) U.S. Cl. 429/90; 700/293; 320/134

(57) ABSTRACT

Some embodiments of the present invention provide systems and methods for more accurately determining the cause of a particular fault in an electrochemical cell based on an impedance measurement characterizing the electrochemical cell. In some very specific embodiments the impedance of an electrochemical cell or stack is measured across a range of frequencies to determine a corresponding impedance signature characterizing the present state of the electrochemical cell or stack. By evaluating the impedance signature in comparison to reference information, a number of faults may be detected. In some more specific embodiments once a corresponding specific fault is determined and an indication is provided to a user and/or a balance-of-plant monitoring system, which may be used to adjust the operating parameters of an electrochemical cell module to compensate for and/or reverse the detrimental effects caused by a particular fault.

### PRIORITY CLAIM

This application claims the benefit, under 35 U.S.C. 119(e), of U.S. Provisional Application Nos. 60/631,232 and 60/679,663 that were respectively filed on Nov. 29, 2004 and May 11, 2005; and, the entire contents of which are hereby incorporated by reference.

### FIELD OF THE INVENTION

The invention relates to electrochemical cells, and, in particular to systems and methods for detecting fault conditions in electrochemical cells.

### BACKGROUND OF THE INVENTION

An electrochemical cell, as defined herein, is an electrochemical reactor that may be specifically designed as either a fuel cell or an electrolyzer cell. Generally, electrochemical cells of both varieties include an anode electrode, a cathode electrode and an electrolyte arranged between the electrodes serving as an ionic conductor. An electrochemical cell also typically includes a respective catalyst layer on one or both sides of the electrolyte layer to facilitate electrochemical reactions on respective sides of the electrolyte layer.

A specific example of an electrochemical cell is a Proton Exchange Membrane Fuel Cell (PEMFC). A PEMFC is a type of fuel cell that includes a polymer membrane as the electrolyte layer (i.e. electrolyte membrane). The reliability and performance of a PEMFC stack is affected by a number of operating parameters. For example, the electrolyte membrane in most PEMFC's must remain moist, and thus humidity within a PEMFC stack must be controlled to prevent both dehydration of the electrolyte membrane and flooding within the stack. Dehydration of an electrolyte membrane leads to an increase in the ionic resistance of the electrolyte membrane. In some cases an electrolyte membrane can be irreversibly damaged as a result of dehydration. On the other hand, an excess of liquid phase water within an electrochemical cell can flood one or more of the catalyst layers, the gas diffusion media and/or flow field channels included in the electrochemical cell. Flooding reduces the free movement of reactants and products throughout the electrochemical cell stack. As a result of flooding cell reversal may occur in one or more cells in a stack, which may in turn cause permanent damage to portions of the stack.

Moreover, the mechanisms by which operating parameters—such as process gas flow rates, humidity, temperature, and pressure—affect the generation of water in a PEMFC fuel cell are interrelated, and so it is difficult to change one operating parameter without affecting the operation of a fuel cell. That is, it is difficult to separate cause and affect relationships of individual operating parameters from one another.

The performance of an electrochemical cell stack can also be deteriorated by the presence of impurities in reactant inflows and/or the build-up of impurities created in parasitic reactions within the electrochemical cell stack. For example, hydrogen fuel for a fuel cell may be provided as a component of a reformate gas mixture as opposed to providing pure hydrogen. The reformate gas mixture is derived by reforming a variety of hydrocarbons (e.g. usually natural gas) and such mixtures often contain carbon monoxide, which can poison an anode catalyst in a fuel cell. For example, if platinum is employed as the anode catalyst, CO-poisoning can occur because carbon monoxide adsorbs on the platinum. In addition to carbon monoxide, other impurities that may cause poisoning of an electrochemical cell include, without limitation, nitrogen dioxide, ammonia, sulfur compounds and volatile organic compounds.

Dehydration, flooding, catalyst poisoning and other fault conditions (e.g. contact resistance faults) typically result in direct current (DC) voltage drops across a PEMFC fuel cell. Accordingly, in most fuel cell applications specifically DC cell or stack potential (i.e. voltage) is used as a performance indicator of a particular fuel cell or fuel cell stack. Since a drop in the cell potential can be the result of many concurrent mechanisms, DC voltage measurements are usually insufficient to determine the cause of a fault. That is, from measurements of voltage alone it is difficult to determine whether degradation of the fuel cell is due to dehydration, flooding, catalyst poisoning or some other fault condition. Incorrectly attributing measurements to a particular fault and subsequently applying an inappropriate response can exacerbate the degradation. For example, flooding can be countered by increasing flow stoichiometry. However, larger flow stoichiometries can lead to faster drying rates. Thus, if a voltage drop due to drying is mistaken as a voltage drop due to flooding, the fault condition may become worse. Moreover, voltage drops are typically only detected once the severity of a fault condition increases to the point where damage to an electrochemical cell module may have already occurred.

### SUMMARY OF THE INVENTION

According to a broad aspect of the invention there is provided a method of detecting a fault in an electrochemical cell module comprising: determining operating characteristics of the electrochemical cell module for at least one discrete frequency to obtain a measured impedance value; providing a reference impedance value and a fault criterion based on a deviation from the reference impedance value; and, comparing the measured impedance value with a reference impedance value to determine whether or not the fault criterion has been satisfied.

According to some aspects, the method further comprises providing an indication that a corresponding fault has been detected if the at least one fault criterion has been satisfied when the measured impedance value is compared with the reference impedance value.

According to some aspects, determining operating characteristics of an electrochemical cell module includes measuring at least one of the Alternating Current (AC) voltage across electrical terminals of the electrochemical cell module and AC current through the electrochemical cell module.

According to some aspects, the at least one fault criterion includes at least one threshold value relating one of: respective magnitudes of the measured and reference impedance values; respective phase angles of the measured and reference impedance values; respective real portions of the measured and reference impedance values; and, respective imaginary parts of the measured and reference impedance values.

According to some aspects, comparing the measured impedance value with the reference impedance value includes calculating a ratio between the measured impedance value and the reference impedance value. According to other aspects, comparing the measured impedance value with the reference impedance value includes calculating a ratio between the magnitude of the measured impedance value and the magnitude of reference impedance value. According to other aspects, comparing the measured impedance value with the reference impedance value includes calculating a ratio between the phase angle of the measured impedance value and the phase angle of reference impedance value. According to other aspects, comparing the measured impedance value with the reference impedance value includes calculating a difference between the measured impedance value and the reference impedance value. According to other aspects, comparing the measured impedance value with the reference impedance value includes calculating a difference between the magnitude of the measured impedance value and the magnitude of reference impedance value. According to other aspects, comparing the measured impedance value with the reference impedance value includes calculating a difference between the phase angle of the measured impedance value and the phase angle of reference impedance value.

According to some aspects, the reference impedance value is one of a plurality of reference impedance values included in a reference impedance signature for the electrochemical cell module, wherein each of the reference impedance values corresponds to a respective discrete frequency. According to more specific aspects, the reference impedance signature is at least partially dependent on a specific set of operating conditions for the electrochemical cell module.

According to some aspects, the method further comprises: determining operating characteristics of the electrochemical cell module for a plurality of discrete frequencies to obtain a measured impedance signature including a corresponding plurality of frequency dependent impedance values; and comparing at least one characteristic of the measured impedance signature with a corresponding at least one characteristic of a reference impedance signature and the at least one fault criterion to determine whether or not the fault criterion has been met. According to more specific aspects, at least one characteristic includes one of impedance magnitude, impedance phase angle, a real portion of an impedance value and an imaginary portion of an impedance value. According to other aspects, the at least one fault criterion is defined in terms of a change to at least one of impedance magnitude, impedance phase angle, a real portion of an impedance value and an imaginary portion of an impedance value.

According to other aspects the method further comprises adjusting at least one operating parameter of the electrochemical cell module to compensate for a detected fault. According to more specific embodiments, the fault detected is a result of flooding, adjusting at least one operating parameter includes increasing flow stoichiometry. According to other more specific embodiments, the fault detected is a result of dehydration, adjusting at least one operating parameter includes increasing humidity within the electrochemical cell module.

According to a broad aspect of the invention there is provided a method of detecting a fault in an electrochemical cell module comprising: characterizing an electrochemical cell module to obtain a reference impedance signature, wherein the reference impedance signature includes a plurality of reference impedance values for a corresponding set of discrete frequency values; obtaining at least one measured impedance signature during the intended use of an electrochemical cell module; providing a reference impedance value and a fault criterion based on a deviation from the reference impedance value; and, comparing at least one characteristic of the reference impedance signature with the at least one characteristic of the at least one measured impedance signature to determine whether or not a fault exists in the electrochemical cell module.

According to some aspects of the invention, the method further comprises providing an indication that a corresponding fault has been detected if at least one respective fault criterion has been satisfied when the measured impedance signature is compared with the reference impedance signature.

According to some aspects of the invention, characterizing the electrochemical cell module and obtaining a measured impedance signature from an electrochemical cell module includes imposing an Alternating Current (AC) voltage or AC current on the Direct Current (DC) voltage or DC current, respectively, wherein the DC voltage and DC current are the result of a specific set of operating parameters defining a mode of use for the electrochemical cell module. According to some specific aspects of the invention, characterizing the electrochemical cell module and obtaining a measured impedance signature from an electrochemical cell module includes measuring the AC voltage across electrical terminals of the electrochemical cell module and AC current through the electrochemical cell module.

According to a broad aspect of the invention there is provided a system for detecting a fault in an electrochemical cell module comprising: at least one sensor connectable to an electrochemical cell module for monitoring at least one operating parameter of the electrochemical cell module; and, a computer program product including a computer usable program code for determining whether or not at least one fault criterion has been satisfied and thereby indicating the presence of a fault in an electrochemical cell module, the computer usable program code including program instructions for: determining operating characteristics of the electrochemical cell module for at least one discrete frequency to obtain a measured impedance value; providing a reference impedance value and a fault criterion based on a deviation from the reference impedance value; and, comparing the measured impedance value with a reference impedance value and at least one fault criterion to determine whether or not the fault criterion has been satisfied.

According to a broad aspect of the invention there is provided a system for detecting a fault in an electrochemical cell module comprising: at least one sensor connectable to an electrochemical cell module for monitoring at least one operating parameter of the electrochemical cell module; and, a computer program product including a computer usable program code for determining whether or not at least one fault criterion has been satisfied and thereby indicating the presence of a fault in an electrochemical cell module, the computer usable program code including program instructions for: characterizing an electrochemical cell module to obtain a reference impedance signature, wherein the reference impedance signature includes a plurality of reference impedance values for a corresponding set of discrete frequency values; obtaining at least one measured impedance signature during the intended use of an electrochemical cell module; providing a fault criterion based on a deviation from the reference impedance value; and, comparing at least one characteristic of the reference impedance signature with the at least one characteristic of the at least one measured impedance signature to determine whether or not the fault criterion has been satisfied.

According to a broad aspect of the invention there is provided a system for detecting a fault in an electrochemical cell module comprising: a sensor means for monitoring at least one operating parameter of the electrochemical cell module; a means for establishing fault criteria based on deviations from reference impedance information; a processor means for determining operating characteristics of the electrochemical cell module for at least one discrete frequency to obtain a measured impedance value; and, a comparison means for determining whether or not at least one fault criterion has been satisfied and thereby indicating the presence of a fault in an electrochemical cell module, the comparison means comparing the measured impedance value with a reference impedance value to determine whether or not the fault criterion has been satisfied.

Other aspects and features of the present invention will become apparent, to those ordinarily skilled in the art, upon review of the following description of the specific embodiments of the invention.

### BRIEF DESCRIPTION OF THE DRAWINGS

For a better understanding of the present invention, and to show more clearly how it may be carried into effect, reference will now be made, by way of example, to the accompanying drawings, which illustrate aspects of embodiments of the present invention and in which:

FIG. 1 is a simplified schematic drawing of a fuel cell module;

FIG. 2 is a simplified schematic drawing of a fault-detection system in combination with the fuel cell module shown in FIG. 1 according to a first embodiment of the invention;

FIG. 3 is a simplified schematic drawing of a test controller shown in FIG. 2;

FIG. 4 is a flow chart illustrating a first method of fault-detection and indication according to an aspect of the invention;

FIG. 5 is a simplified schematic drawing of a fault detection system in combination with a fuel cell module according to a second embodiment of the invention;

FIG. 6 is a simplified schematic drawing of a fault detection system in combination with a fuel cell module according to a third embodiment of the invention;

FIG. 7 is a flow chart illustrating a method of determining an impedance signature according to an aspect of the invention;

FIG. 8 is a flow chart illustrating a method of characterizing faults of an electrochemical cell according to an aspect of the invention;

FIG. 9 is a plot of fuel cell voltage against time, provided as an illustrative example, showing the effect of carbon monoxide (CO) poisoning;

FIG. 10 is a Bode plot, provided as an illustrative example, showing changes in impedance magnitude as a function of CO-poisoning;

FIG. 11 is a Bode plot, provided as an illustrative example, showing changes in impedance phase angle as a function of CO-poisoning;

FIG. 12 is a Bode plot, provided as an illustrative example, showing impedance magnitude as a function of frequency with and without the impedance contribution of current collectors in a fuel cell stack;

FIG. 13 is a Bode plot, provided as an illustrative example, showing impedance phase angle as a function of frequency with and without current collectors;

FIG. 14 is a flow chart illustrating a method of detecting contact resistance according to an embodiment of the invention;

FIG. 15 is a simplified schematic drawing of a multiplexer-switching system for measuring AC impedance, Z(f), according to an embodiment of the invention;

FIG. 16A is a Bode plot, provided as an illustrative example, showing changes in impedance magnitude as a function of dehydration;

FIG. 16B is a Bode plot, provided as an illustrative example, showing changes in impedance phase angle as a function of dehydration;

FIG. 16C is a Bode plot, provided as an illustrative example, showing changes in impedance magnitude as a function of flooding;

FIG. 16D is a Bode plot, provided as an illustrative example, showing changes in impedance phase angle as a function of flooding;

FIG. 16E is a Bode plot, provided as an illustrative example, showing changes in impedance magnitude as a function of CO-poisoning;

FIG. 16F is a Bode plot, provided as an illustrative example, showing changes in impedance phase angle as a function of CO-poisoning;

FIG. 17A is a Bode plot, provided as an illustrative example, showing changes in impedance magnitude as a function of dehydration;

FIG. 17B is a Bode plot, provided as an illustrative example, showing changes in impedance phase angle as a function of dehydration;

FIG. 17C is a Bode plot, provided as an illustrative example, showing changes in impedance magnitude as a function of flooding;

FIG. 17D is a Bode plot, provided as an illustrative example, showing changes in impedance phase angle as a function of flooding;

FIG. 17E is a Bode plot, provided as an illustrative example, showing changes in impedance magnitude as a function of CO-poisoning;

FIG. 17F is a Bode plot, provided as an illustrative example, showing changes in impedance phase angle as a function of CO-poisoning;

FIG. 18 is a first flow chart illustrating very specific example method steps for detecting various fault conditions within a fuel cell during operation according to an aspect of the invention; and

FIG. 19 is a second flow chart illustrating very specific example method steps for detecting various fault conditions within a fuel cell during operation according to an aspect of the invention.

### DETAILED DESCRIPTION OF THE INVENTION

Many fault conditions result in direct current (DC) voltage drops across an electrochemical fuel cell. Since a drop in the cell potential can be the result of many concurrent mechanisms, DC voltage measurements are usually insufficient to determine the cause of a fault. That is, for example, from measurements of voltage alone it is difficult to determine whether degradation of the fuel cell is due to dehydration, flooding, catalyst poisoning or some other fault condition. Incorrectly attributing measurements to a particular fault and subsequently applying an inappropriate response can exacerbate the degradation. Moreover, voltage drops are typically only detected once the severity of a fault condition increases to the point where damage to an electrochemical cell module may have already occurred.

By contrast, some embodiments of the present invention provide systems and methods for more accurately determining the cause of a particular fault in an electrochemical cell based on an impedance measurement characterizing the electrochemical cell. In accordance with some very specific aspects of the invention, the impedance of an electrochemical cell or stack is measured across a range of frequencies to determine a corresponding impedance signature characterizing the present state of the electrochemical cell or stack. By evaluating the impedance signature in comparison to reference information a number of faults may be detected. As such, information about impedance signature measurements can be used to set a range of threshold for characterizing particular faults (e.g. drying, flooding, catalyst poisoning, contact resistance failures, etc.) according to corresponding effects on changes in the impedance signature of an electrochemical cell. In some cases the faults may even be detected before there is a sizable change in the voltage across the electrochemical cell or stack.

In accordance with more specific aspects of the invention once a corresponding specific fault is determined, an indication is provided to a user and/or a balance-of-plant monitoring system. Additionally and/or alternatively, the indication that a particular fault has occurred may be used to adjust the operating parameters of an electrochemical cell module to compensate for and/or reverse the detrimental effects caused by a particular fault.

In practice a number of electrochemical cells, all of one type, can be arranged in stacks having common features, such as process gas/fluid feeds, drainage, electrical connections and regulation devices. That is, an electrochemical cell module is typically made up of a number of individual electrochemical cells connected in series to form an electrochemical cell stack. The electrochemical cell module also includes a suitable combination of associated structural elements, mechanical systems, hardware, firmware and software that is employed to support the function and operation of the electrochemical cell module. Such items include, without limitation, piping, sensors, regulators, current collectors, seals, insulators and electromechanical controllers.

There are a number of different electrochemical cell technologies and, in general, this invention is expected to be applicable to many types of electrochemical cells. Very specific example embodiments of the invention have been developed for use with Proton Exchange Membrane Fuel Cells (PEMFC), some of which have been described below. Other types of fuel cells may include, without limitation, Alkaline Fuel Cells (AFC), Direct Methanol Fuel Cells (DMFC), Molten Carbonate Fuel Cells (MCFC), Phosphoric Acid Fuel Cells (PAFC) and Solid Oxide Fuel Cells (SOFC). Similarly, other types of electrolyzer cells include, without limitation, Solid Polymer Water Electrolyzer (SPWE).

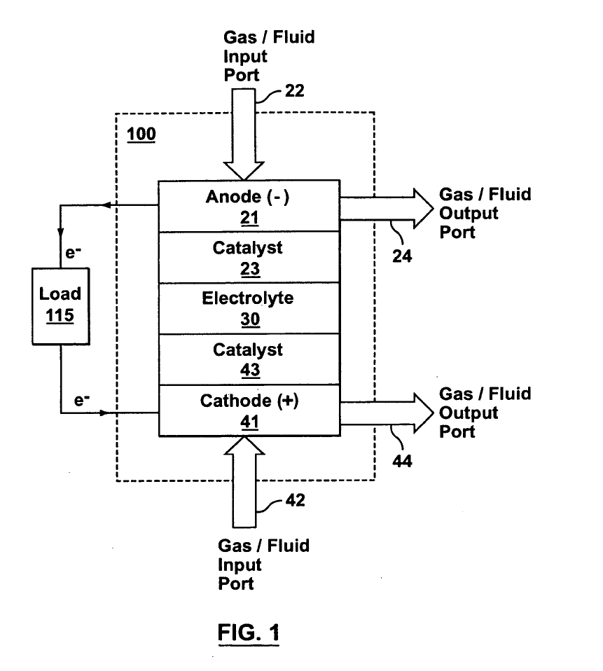

Referring to FIG. 1, shown is a simplified schematic diagram of a PEMFC module, simply referred to as fuel cell module 100 hereinafter, that is described herein to illustrate some general considerations relating to the operation of electrochemical cell modules. It is to be understood that the present invention is applicable to various configurations of electrochemical cell modules that each include one or more electrochemical cells.

The fuel cell module 100 includes an anode electrode 21 and a cathode electrode 41. The anode electrode 21 includes a gas input port 22 and a gas output port 24. Similarly, the cathode electrode 41 includes a gas input port 42 and a gas output port 44. An electrolyte membrane 30 is arranged between the anode electrode 21 and the cathode electrode 41.

The fuel cell module 100 also includes a first catalyst layer 23 between the anode electrode 21 and the electrolyte membrane 30, and a second catalyst layer 43 between the cathode electrode 41 and the electrolyte membrane 30. In some embodiments the first and second catalyst layers 23, 43 are directly deposited on the anode and cathode electrodes 21, 41, respectively.

A load 115 is connectable between the anode electrode 21 and the cathode electrode 41.

In operation, hydrogen fuel is introduced into the anode electrode 21 via the gas input port 22 under some predetermined conditions. Examples of the predetermined conditions include, without limitation, factors such as flow rate, temperature, pressure, relative humidity and a mixture of the hydrogen with other gases. The hydrogen reacts electrochemically according to reaction (1), given below, in the presence of the electrolyte membrane 30 and the first catalyst layer 23.
H₂→2H⁺+2e⁻ (1)
The chemical products of reaction (1) are hydrogen ions and electrons. The hydrogen ions pass through the electrolyte membrane 30 to the cathode electrode 41 while the electrons are drawn through the load 115. Excess hydrogen (sometimes in combination with other gases and/or fluids) is drawn out through the gas output port 24.

Simultaneously an oxidant, such as oxygen in the air, is introduced into the cathode electrode 41 via the gas input port 42 under some predetermined conditions. Examples of the predetermined conditions include, without limitation, factors such as flow rate, temperature, pressure, relative humidity and a mixture of the oxidant with other gases. The excess gases, including the unreacted oxidant and the generated water are drawn out of the cathode electrode 41 through the gas output port 44.

The oxidant reacts electrochemically according to reaction (2), given below, in the presence of the electrolyte membrane 30 and the second catalyst layer 43.
1/2O₂+2H⁺+2e→H₂O (2)

The chemical product of reaction (2) is water. The electrons and the ionized hydrogen atoms, produced by reaction (1) in the anode electrode 21, are electrochemically consumed in reaction (2) in the cathode electrode 41. The electrochemical reactions (1) and (2) are complementary to one another and show that for each oxygen molecule (O₂) that is electrochemically consumed, two hydrogen molecules (H₂) are electrochemically consumed.

In a similarly configured water supplied electrolyzer the reactions (2) and (1) are respectively reversed in the anode and cathode. This is accomplished by replacing the load 115 with a voltage source and supplying water to at least one of the two electrodes. The voltage source is used to apply an electric potential that is of an opposite polarity to that shown on the anode and cathode electrodes 21 and 41, respectively, of FIG. 1. The products of such an electrolyzer include hydrogen and oxygen.

Dehydration results in a dramatic change in morphology and material properties of the electrolyte membrane 30. When dehydration occurs, there is a reduction in the size of the ionic clusters and the width of the interconnecting channels within the microstructure of the polymer compound used for the electrolyte membrane 30. As a result hydrogen proton (H⁺) mobility is reduced, which in turn, increases ohmic resistance through the electrolyte membrane 30. As the ohmic resistance of the electrolyte membrane 30 increases additional heat is released which imposes additional thermal stresses on dehydrated regions of the electrolyte membrane 30. Dehydration of the electrolyte membrane 30 causes changes to the microstructures in the polymer, which may lead to permanent performance degradation even after the electrolyte membrane 30 is re-hydrated, since such changes are cumulative and not completely reversible.

In extreme cases water will be completely removed and local temperature will rise above the glass transition temperature or melting point of the electrolyte membrane 30. Under these conditions dehydrated regions of the electrolyte membrane 30 can burn and possibly rupture. A ruptured electrolyte membrane 30 can create a pneumatic short circuit between the anode electrode 21 and cathode electrode 41, thereby allowing intermixing of hydrogen fuel and oxidant. Failures of this type in one cell within a serial PEMFC stack will halt current production of the entire stack. Moreover, if the fuel and oxidant are permitted to mix at high temperatures in the presence of an active catalyst there is the potential for an explosive fuel ignition. There is an elevated potential for catastrophic failures of this sort in high current applications where the geometric power densities are high (e.g. in vehicular power plants operating at 0.5 Watts per cm² per cell or more).

Macroscopic physical deformation, such as delamination of a catalyst layer from the electrolyte membrane 30, may occur after partial sudden drying and re-hydration.

On the other hand, excess water in the porous layers of a fuel cell module 100 can also be a problem. Operating a PEMFC at moderate or high current densities and with humidified reactants can result in water accumulation at the cathode electrode 41, and especially within the gas diffusion layer of the fuel cell (not shown in FIG. 1). A similar set of conditions may result in flooding at the anode 21. Furthermore, reduced reactant flow rates may also cause flooding because there is proportionally less gas present to remove the water from each cell in a stack. The presence of liquid water leads to a two-phase angle flow that can hinder reactant transport to catalyst sites. Macroscopic water layers can result in preferential flow through alternative channels and the subsequent reduction in the local partial pressure of reactants in blocked channels.

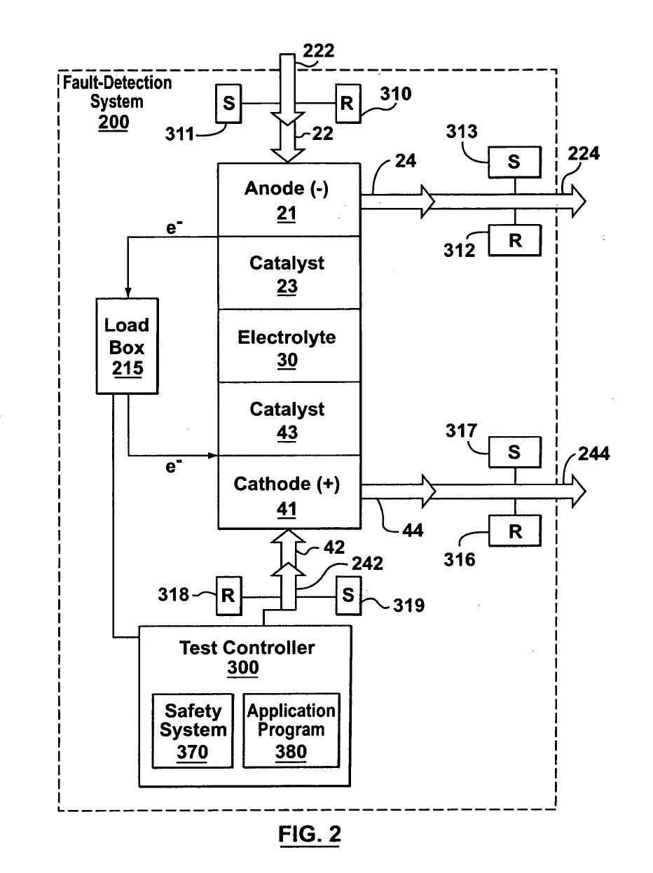

Referring now to FIG. 2, shown is a schematic drawing of a simplified fault-detection system 200 coupled to the fuel cell module 100 (illustrated in FIG. 1). The fault-detection system 200 shown in FIG. 2 includes some basic features found in a practical fuel cell testing system. Those skilled in the art would appreciate that a practical testing system also includes a suitable combination of sensors, regulators (e.g. for temperature, pressure, humidity and flow rate control), control lines and supporting apparatus/instrumentation in addition to a suitable combination of hardware, software and firmware. Furthermore, it is also to be understood that the description provided herein, relating to the fault-detection system 200, is by no means meant to restrict the scope of the claims following this section. Again, this fault-detection system is configured for a PEM-type fuel cell, and the sensors, regulators, etc. would need to be varied for other types of fuel cells.

The fault-detection system 200 includes a test controller 300 that is used to manage fuel cell testing by a skilled operator. In some embodiments the test controller 300 is made up of a single server or computer having at least one microcomputer; and, in other embodiments the test controller 300 is made up of a combination of microcomputers appropriately configured to divide the tasks associated with fuel cell testing amongst the combination of microcomputers.

In some embodiments the test controller 300 is made up of a computer program product having a computer usable program code, a modified safety system 370 and at least one application program 380. In the present embodiment of the invention the test controller 300 includes a memory device (not shown) storing a computer usable program code having instructions for the modified safety system 370 and the at least one application program 380. The modified safety system 370, in accordance with an embodiment of the invention, is capable of calling a fault recovery sequence in the event that a corresponding fault threshold has been violated. The at least one application program 380 contains user designed test vectors for varying the process and operating parameters of a fuel cell module under test and collecting impedance measurements across a range of frequencies. In some embodiments, application programs are made up of computer usable program code having data and instructions for executing a sequence of test vectors defining a trial.

The fault-detection system 200 also includes a number of physical connections to ports of the fuel cell module 100 that are used to supply required gases and vent exhaust and un-used gases from the fuel cell module 100. The physical connections include gas supply ports 222 and 242 and, gas exhaust ports 224 and 244. The gas supply ports 222 and 242 are coupled to the gas input ports 22 and 42 of the fuel cell module 100, respectively. The gas exhaust ports 224 and 244 are coupled to gas output ports 24 and 44 of the fuel cell module 100, respectively.

Additionally, there are a number of sensor connections between the fault-detection system 200 and the fuel cell module 100. The sensor connections are advantageously used to monitor reaction products and electrical outputs produced by the fuel cell module 100 as well as other process and operating parameters. In the present embodiment, the fault-detection system 200 includes sensors 311, 313, 317 and 319 that are connected to ports 222, 224, 244 and 242 (of the fuel cell module 100), respectively. The sensors 311, 313, 317 and 319, may be used, for example, to monitor one or more of temperature, pressure, composition and relative humidity of input and output gases or fluid flows through any of the ports 222, 224, 244 and 242.

The test controller 300 is also electrically connected to the regulators 310, 312, 316 and 318 that are used to regulate process and operating parameters associated with ports 222, 224, 244 and 242, respectively.

Moreover, within the context of the fault-detection system 200, the load 115 shown in FIG. 1, has been replaced by a load box 215. The voltage and current drawn by the load box 215 is controllable so that different loading conditions can be imposed on the fuel cell module 100 during testing.

In operation, the test controller 300 executes test vectors provided in the at least one application program 380. This is done by extracting the test vectors from the at least one application program 380 and, in turn, varying the loading conditions provided by the load box 215 and/or other process and operating parameters in accordance with the test vectors provided. The latter is accomplished by having the test controller 300 transmit control signals to the regulators 310, 312, 316 and 318. The test controller 300 then receives measurements related to the impedance of a particular cell, a group of cells and/or the fuel cell stack as a whole for one or more frequencies. Preferably, the impedance measurements are collected across a range of frequencies so as to produce a corresponding impedance signature for an individual fuel cell, a group of fuel cells and/or the fuel cell stack as a whole. Additionally and/or alternatively, the fault-detection system 200 may be configured to also measure characteristics relating to reaction products, other electrical outputs and/or other process and operating parameters from the sensors 311, 313, 317 and 319. The measurements can be recorded and evaluated, as described below.

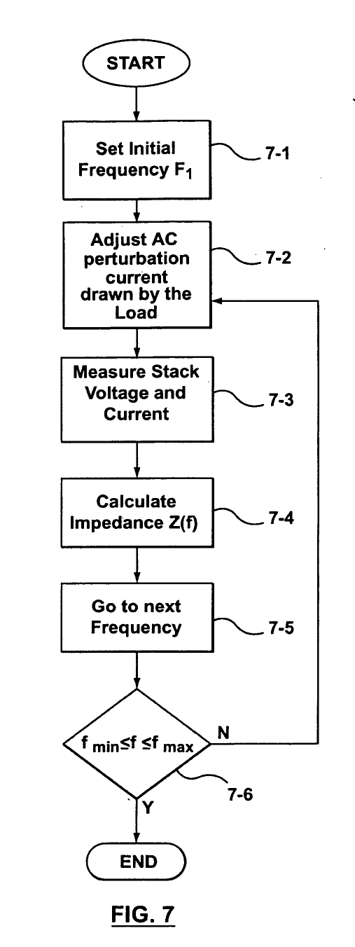

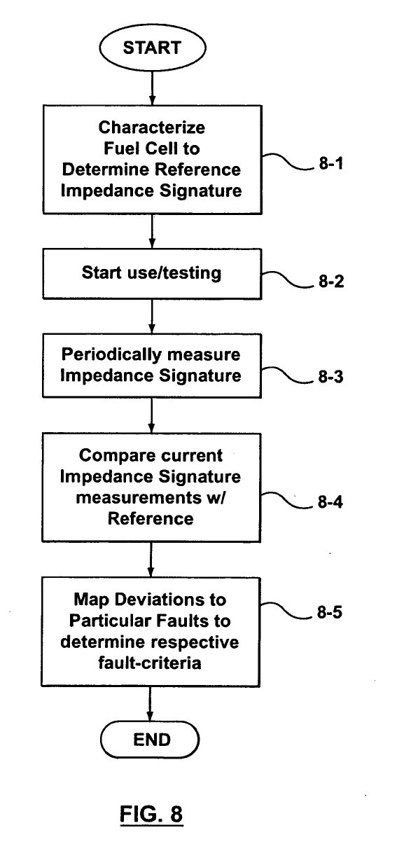

Described below with reference to FIGS. 7 and 8, changes in the impedance signature of a fuel cell module can be characterized to determine the effects of various faults. A set of fault criteria can be determined from the test data for use as reference impedance signature information. During actual use of a fuel cell module (e.g. fuel cell module 100) (outside the controlled setting of a testing laboratory), the reference impedance signature information can be compared with new impedance signature measurements to monitor the condition of the fuel cell module and determine if a fault occurs. For example, a fault-detection system (e.g. fault-detection system 200) may be used to monitor the condition of an operating fuel cell module and produce fault condition signals to indicate faults such as dehydration, flooding, increased contact resistance, loss of perimeter seals, catalyst poisoning, catalyst sintering, catalyst aging, membrane puncturing, catalyst delamination, catalyst degradation, cell reversal, presence of contaminants, corrosion, gas/liquid crossover, chemical attack (peroxide, etc), changes in ionic conductivity, or changes in electrode substrate thickness, for example, in many types of electrochemical cells.

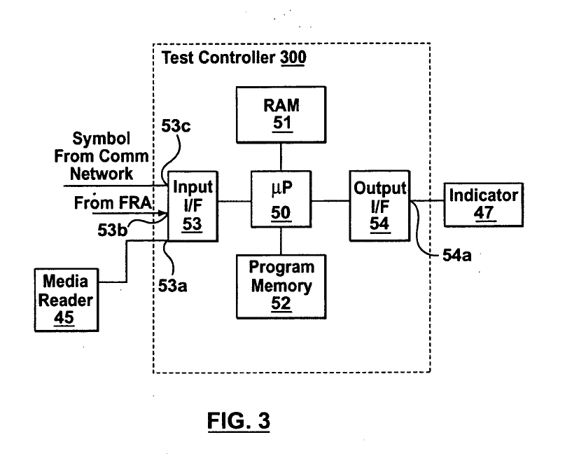

Referring to FIG. 3, and with continued reference to FIG. 2, shown is a simplified schematic drawing of the test controller 300 shown in FIG. 2 according to a very specific embodiment of the invention. The test controller 300 includes a processor 50 connected to a Random Access Memory (RAM) module 51, a program memory module 52, an input interface module 53, and an output interface module 54.

The input interface module 53 includes first, second and third inputs 53a, 53b and 53c, respectively. The first input 53a is coupled to receive data signal transmissions from a media reader, shown for example as media reader 45. The media reader 45 is operable to read information from at least one of a number of data storage devices (not shown), including but not limited to, a CD, a DVD, flash memory, portable hard disks and the like. The second input 53b is coupled to receive impedance signature information obtained by the fault-detection system 200. The third input 53c is coupled to receive and/or transmit information to or from the test controller 300 over a transmission medium to provide additional connectivity to the test controller 300. In some embodiments the transmission medium employed may be one of wireless data channel, a fiber-optic channel, a telephone line and the like. Additionally and/or alternatively, the input interface module 53 may only include the second input 53b to collect impedance signature information obtained by the fault-detection system 200. In such embodiments, reference impedance signature information is stored within the test controller 300 on one of the RAM module 51, the program memory module 52 or another memory module (not shown).

The test controller 300 and/or peripheral storage device (not shown) connectable to the test controller 300 (e.g. the media reader 45) includes computer usable program code for directing the processor 50 to determine whether or not measured impedance signature information in comparison to reference impedance signature information meets at least one set of fault criteria of a corresponding fault condition to thereby detect the fault. If a fault is detected the additional computer usable program code may also be provided for providing a signal indicating that a specific fault condition has been detected. Additionally, and/or alternatively, a computer usable program code for achieving these functions may be received through transmission medium via the third input 53c and stored in the program memory 52.

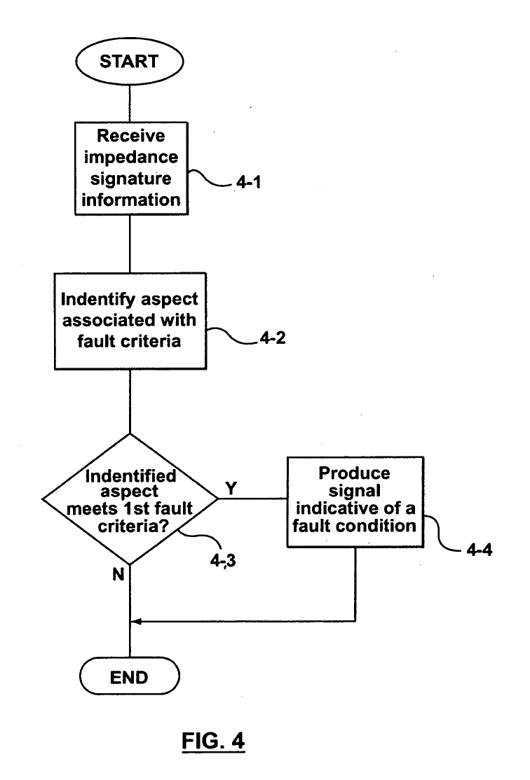

FIG. 4, shows a flow chart summarizing a first method of fault-detection and indication according to an aspect of the invention, as just described herein with reference to FIGS. 2 and 3. Starting at step 4-1 the test controller 300 receives impedance signature information. In some embodiments, impedance signature information includes, for example a specific portion of the measured impedance signature and/or a characteristic value or value set derived from the measured impedance signature. Accordingly, the computer useable program code employed in accordance with aspects of the invention includes a specific set of instructions for receiving the impedance signature information.

At step 4-2, an aspect or set of aspects of the impedance signature information is identified for comparison with a set of fault criteria for determining whether or not a fault condition exists. Accordingly, the computer useable program code employed in accordance with aspects of the invention includes a specific set of instructions for identifying an aspect or set of aspects of the impedance signature information for comparison with a set of fault criteria for determining whether or not a fault condition exists that is measurable using the instruments available.

Fault criteria may include a range, or multiple ranges, of impedance values and/or portions of impedance values. Fault criteria may also include a range of ratio or difference values.

At step 4-3, it is determined whether or not a fault condition exists according to the fault criteria. Accordingly, the computer useable program code employed in accordance with aspects of the invention, includes a specific set of instructions for determining whether or not a fault condition exists according to the fault criteria. If a fault condition is detected (yes path, step 4-3) a signal corresponding to the particular fault condition detected is produced at step 4-4. Accordingly, the computer useable program code employed in accordance with aspects of the invention includes a specific set of instructions for producing a signal corresponding to the particular fault condition detected. On the other hand, if a fault condition is not detected (no path, step 4-3) then the method ends, to be started again as desired. The signal produced may include, for example, a bit value in a register accessible by the output interface 54, a binary value transmitted to the output interface 54 or the like. Subsequently, the output interface 54 may supply a digital signal to a user, a peripheral device (e.g. indicator 47) and/or another monitoring system.

Additionally and/or alternatively, a number of different fault signals may be produced representing respective different fault conditions associated with respective different fault criteria. Additionally and/or alternatively, an entire impedance signature (e.g. magnitude, phase angle, real part or imaginary part) over a range of frequencies may be evaluated against corresponding fault criteria to determine whether or not a respective fault condition signal should be produced.

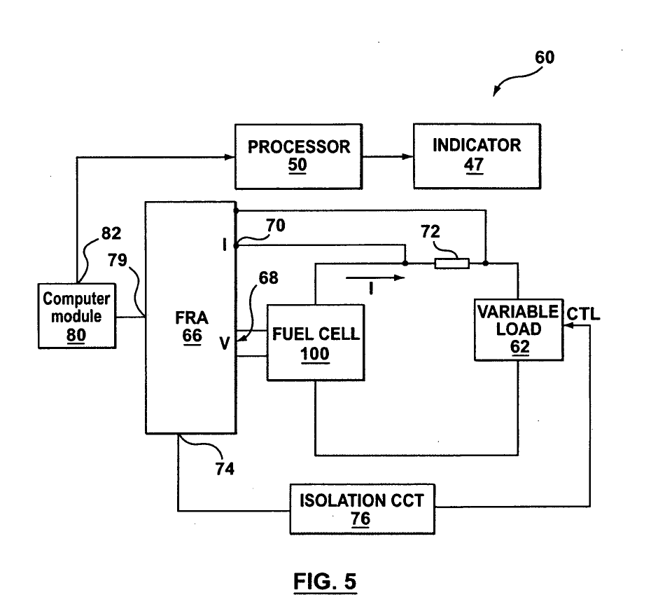

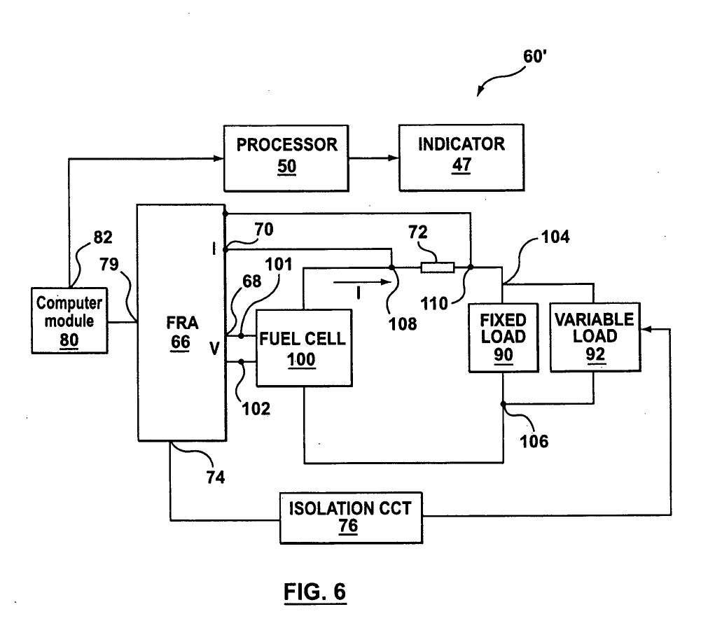

Turning to FIGS. 5 and 6, shown are simplified schematic drawings of fault detection systems 60 and 60′, respectively. The fault detection systems 60 and 60′, and accordingly, elements common to both share common reference numerals. Moreover, for the sake of brevity the fault detections systems 60 and 60′ are referred to hereinafter as the systems 60 and 60′, respectively. The primary difference between the two fault detection systems 60 and 60′ is that a variable load 62 included in fault detection system 60 is replaced by a combination of a fixed load 90 and a variable load 92 in fault detection system 60′. The following will further clarify the arrangement and operation of both fault detection systems 60 and 60′.

The systems 60 and 60′ employ the use of Electrochemical Impedance Spectroscopy (EIS). In accordance with some embodiments of the invention EIS is used to identify the effects of various fault conditions in electrochemical cells such as for example, but not limited to, dehydration, flooding, catalyst poisoning and contact resistance faults. A clear advantage of EIS is the capability to detect changes in impedance during intended usage with minimal perturbations of an electrochemical cell system.

Referring specifically to FIG. 5, the system 60 is shown in combination with the fuel cell module 100. The system 60 includes a variable load 62, a Frequency Response Analyzer (FRA) 66, a processor module 50, an indicator module 47, an optional isolation circuit 76 and a computer module 80. The variable load 62 is coupled to receive power from the fuel cell module 100. The FRA 66 is connected to measure current provided to the variable load 66 through a resistor 72 and the voltage across the fuel cell module 100. The FRA 66 is further coupled to provide instructions to the variable load 62 via isolation circuit 76 and to provide measurement information to the computer module 80. The computer module 80 is further coupled to provide impedance signature information to the processor 50, which is coupled to indicator 47 as described above with reference to FIG. 3.

In operation, current drawn by the variable load 62, receiving energy from the fuel cell module 100, is adjusted to produce a periodic variation in the net load to the fuel cell module 100 while the impedance of the fuel cell module 100 is measured. The impedance is measured by the FRA 66 having a voltage input shown generally at 68 for measuring voltage across the fuel cell module 100 and a current input shown generally at 70 for receiving a measure of current through the resistor 72 in series with the fuel cell module 100 and the load 62. The impedance of the fuel cell module 100 may be calculated with Ohm's Law, Z=V/I, where V and I are complex numbers representing both phase angle and magnitude (or real part and imaginary part) of the voltage and current, respectively.

The current sensing resistor 72 is an example of various types of devices that may be used as a current sensing element. Other devices, such as, for example, a Rogowski coil or current transformer may be used.

In some embodiments the FRA 66 may be a Solartron™1255B Frequency Response Analyzer or a GAMRY™ FC350 Fuel Cell EIS System. The FRA 66 device has a signal generator output 74 at which it generates a control signal. For example, the control signal may be a sine wave having a frequency in the approximate range of 1 Hz to about 100 kHz. For Hydrogenics fuel cell stacks, it has been determined that a frequency range of approx. 1 Hz to 10 kHz is the most useful for detecting the different fault conditions. The amplitude of the control signal will typically be selected based on the input levels required to control the variable load 62. Other spectral ranges, extending below 1 Hz and above 100 kHz may be used to identify other properties of PEMFC and other types of fuel cells. In general, the frequency range used will depend on the fuel cell type, construction or configuration, operating point (output current, temperature, pressure etc.) and failure mode to be detected. For example, the thickness and conductivity of the membrane influences the measurements.

Separate or concurrent impedance measurements in distinct frequency ranges or bands of frequency ranges can be used to discern and identify dehydration and flooding conditions in a fuel cell. Other separate or concurrent impedance measurements in other distinct frequency ranges can be used to discern and identify other fault conditions.

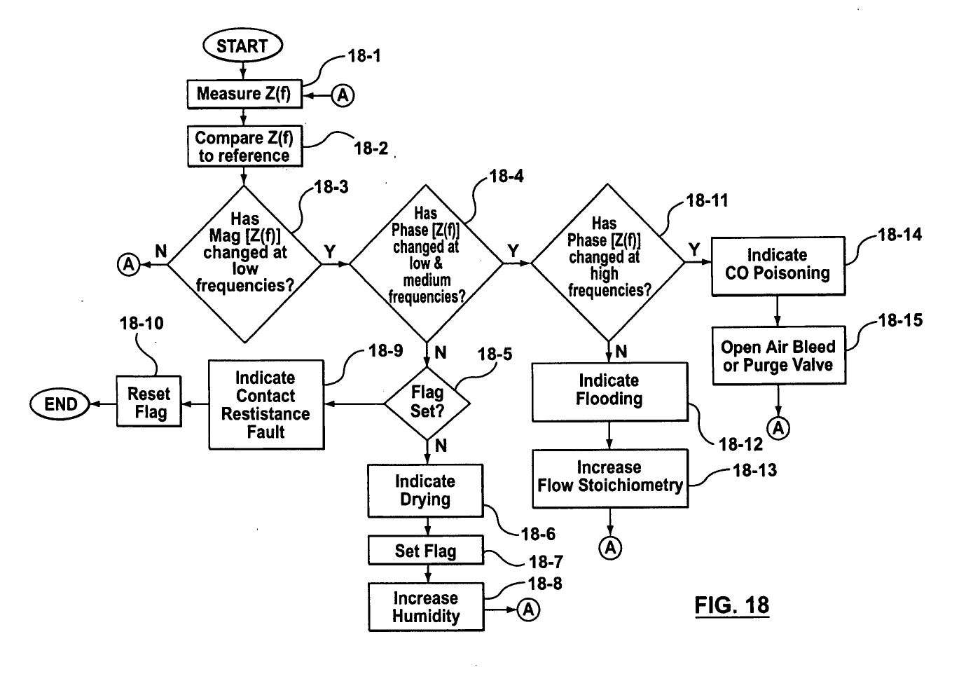

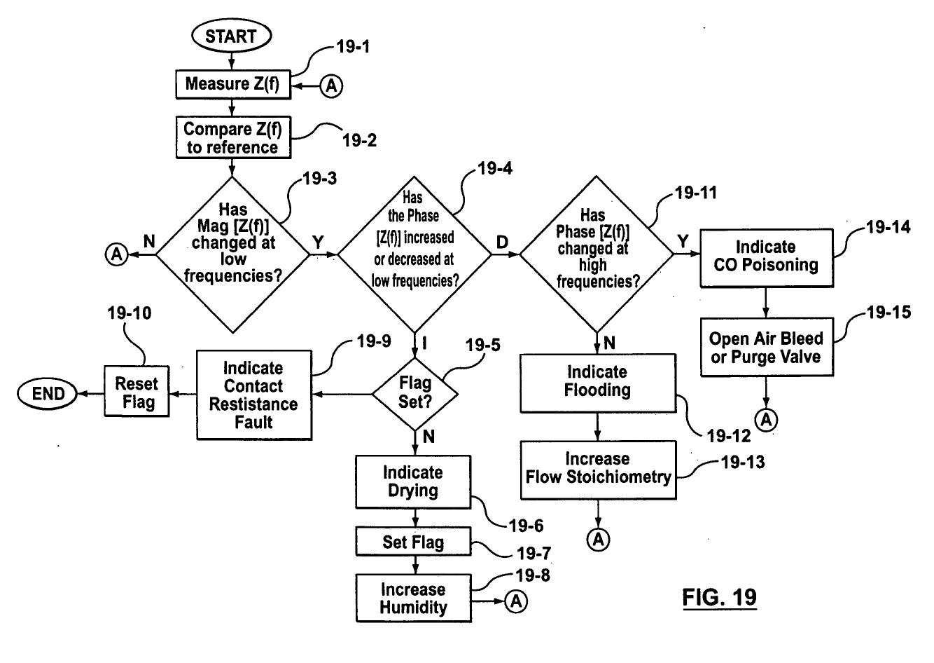

In other embodiments of the invention, impedance signature information collected in response to a multi-frequency load having frequency components at two or more frequencies, or frequency ranges, may be used. For example, the variable load 62 may be configured to draw a current from the fuel cell module 100 with a frequency component at 5 Hz and other components at 100 Hz and 1 kHz. Typically, although not necessarily, this will be done by generating a control signal having the desired frequency components. The impedance signature information of a fuel cell module in response to the multi-frequency load may be measured and compared to known fault conditions relating to the property, as described below with reference to FIGS. 18 and 19.

With continued reference to FIG. 5, the signal produced at the output 74 is provided to an isolation circuit 76 which may include a voltage follower, for example, to minimize ground loops and potential errors in DC levels due to voltage drift during measurements. The isolation circuit 76 produces a signal that controls the variable load 62, thereby causing a perturbation of a few percent of the main load current. This causes the fuel cell module 100 to supply a current with a periodically varying component relative to a nominal current supplied to the variable load 62 (without the perturbation signal). The AC current and the AC voltage produced by the fuel cell module 100 are measured at the inputs 70 and 68, respectively.

In accordance with some aspects of the invention producing a perturbation signal using a variable load may further involve producing a representation of the property or properties of the impedance spectrum. This may involve producing a representation of a ratio of a measured impedance value (magnitude and/or phase angle, real and/or imaginary part) to a reference impedance value. This ratio may be of a measured impedance value to a reference impedance value associated with a perturbation signal having a particular frequency, or a perturbation signal of a plurality of frequencies in a frequency band. In accordance with other aspects producing a perturbation signal may further involve determining whether the ratio meets the criteria associated with the specific fault condition. Producing a perturbation signal may involve producing a representation of a difference between a measured impedance value (magnitude and/or phase angle, real and/or imaginary part) and a reference impedance value. This difference may be determined between a measured impedance value and a reference impedance value associated with a perturbation signal having a particular frequency. Additionally and/or alternatively, in accordance with other aspects of the invention producing a perturbation signal may further involve determining whether the difference meets the criteria associated with the specific fault condition.

The FRA 66 is connected to the computer module 80 via the interface 79. The computer 80 may be programmed to run commercial EIS software packages such as ZPLOT™ and ZVIEW™ available from Scribner Associates™ Inc. of North Carolina, U.S.A., or Framework and Echem Analyst by Gamry Instruments™ of. Warminster, U.S.A. to produce an impedance signature across a range of frequencies or at an individual frequency, a ratio of a measured impedance value (magnitude and/or phase angle and/or real part and/or imaginary part) to a reference impedance value or a difference between a measured impedance value (magnitude and/or phase angle and/or real part and/or imaginary part) and a reference impedance value.

EIS software packages, such as those identified above, may also be used to analyze the impedance signature of a fuel cell to provide an equivalent circuit for the fuel cell. The values of components (i.e. resistor, capacitor, inductors, etc.) in an equivalent circuit for a fuel cell under test may be compared with the magnitude of corresponding components in the equivalent circuit of a similar fuel cell that is know to have no fault conditions, or is known to have one or more fault conditions. Such a comparison may be used to identify fault conditions in the fuel cell under test.

Turning to FIG. 6, shown is the system 60′. Again, the primary difference between the two fault detection systems 60 and 60′ is that the variable load 62 included in the fault detection system 60 is replaced by a combination of a fixed load 90 and a variable load 92 in the fault detection system 60′. More specifically, the load includes a fixed load 90 and a variable load 92 connected in parallel. The operation of system 60′ is similar to the system 60 described above and for the sake of brevity a complete description of the operation will not be provided. The system 60′ may be used for quality control during manufacturing. Additionally and/or alternatively the system 60′ may be scaled down and implemented in a handheld device, for example, having terminals 101 and 102 for connection to the fuel cell and terminals 104 and 106 for connection to the load 90, and terminals 108 and 110 for connection to a current sensing resistor in the load circuit. In such an embodiment, the frequency response analyzer 66, computer 80, processor 50 and isolation circuit 76 may be integrated into a portable computer-product programmed to execute the functions of the FRA 66 and computer module 80, or a limited set of functions.

The fault-detection systems provided by some embodiments of the present invention, (e.g. systems such as 60 and 60′) can be used to measure the impedance signature of an electrochemical cell across a range of frequencies at any time during the operation of the electrochemical cell. Initially, however, it is beneficial to characterize a particular specific design of an electrochemical cell to match changes in the impedance signature to particular faults so that a corresponding set of fault criteria can be produced to evaluate the one or more electrochemical cells of the same design during their intended operation. To these ends, shown in: FIG. 7 is a flow chart illustrating a method of determining an impedance signature according to an aspect of the invention that may be employed at any time during the testing and intended use of a fuel cell module; and, FIG. 8 is a flow chart illustrating a method of characterizing faults of an electrochemical cell according to an aspect of the invention.

Referring to FIG. 7, the method of determining an impedance signature starts at step 7-1 by selecting an initial frequency at which the impedance of the electrochemical cell is to be determined. Step 7-2 includes adjusting the current drawn by the load (e.g. variable load 62). Step 7-3 includes measuring both the voltage across the electrochemical cell stack (or a single cell, or a group of cells) and the current circulating through the electrochemical cell stack. Using the voltage and current measurements, step 74 includes calculating a value for the impedance at the selected frequency. Steps 7-5 and 7-6 include selecting a new frequency in a range of frequencies and going back to step 7-2 if there are still frequencies in the range of frequencies to be tested. The method stops when all of the frequencies in the range of frequencies have been evaluated to determine a corresponding set of impedance values for a given set of conditions. A set of impedance values over a frequency range is considered the impedance signature of the electrochemical cell for a given set of conditions.

The system and/or device employed for use as an impedance-measuring device may be based on a sequential frequency method and may be a Frequency Response Analyzer, a Phase Sensitive Detection system such as a Lock-in Amplifier, or an oscilloscope providing Lissajous figures or accurate amplitude and phase measurement of the fuel cell current and voltage. It may also be a data acquisition device using a fast Fourier transform (FFT) of the fuel cell current and voltage response signals, and may use different types of excitation signal such as steps, multiple frequencies (multisine, pseudo-random white noise spectrum, etc).

Turning to FIG. 8, the method characterizing faults of an electrochemical cell includes, at step 8-1, measuring the impedance signature under nominal or preferred operating conditions, which is later used as reference impedance signature Z_{REF}(f) defined at one or more discrete frequencies. Step 8-2 includes operating the electrochemical cell under a variety of controlled fault conditions to determine changes to the reference impedance signature Z_{REF}(f) as a function of the fault conditions. Accordingly, step 8-3 includes periodically measuring the impedance signature to gather information about the effects of the fault conditions on the electrochemical cell under test. Steps 84 and 8-5 include comparing the impedance signature measurements collected during step 8-3 to the reference impedance signature Z_{REF}(f) and mapping deviations to particular fault conditions to derive corresponding fault criteria for each of the faults that may be used to detect such faults during the intended use of an electrochemical cell of the same design. In many cases the reference impedance signature Z_{REF}(f) is also at least partially dependent on a specific set of operating conditions and comparisons with measurements during use of an electrochemical cell stack, in accordance with embodiments of the invention, preferably use the closest Z_{REF}(O)O for the current set of operating conditions the electrochemical cell stack is currently being used under when in-use impedance measurements are made. Additionally and/or alternatively, it may be possible to map deviations in one of voltage and current measurements to particular fault conditions to derive corresponding fault criteria for each of the faults that may be used to detect such faults during the intended use of an electrochemical cell of the same design, so that impedance values do not need to be calculated. In particular, in a fuel cell it is desirable to analyze the performance of each fuel cell individually. Since the current will be substantially the same for all fuel cells in a stack, assuming that there is not significant leakage current, a notable characteristic for each fuel cell will be the respective voltage across the individual fuel cell, and for some applications and/or some other types of electrochemical cells, it may be sufficient to measure the voltage across a particular cell and/or the current through the whole stack.

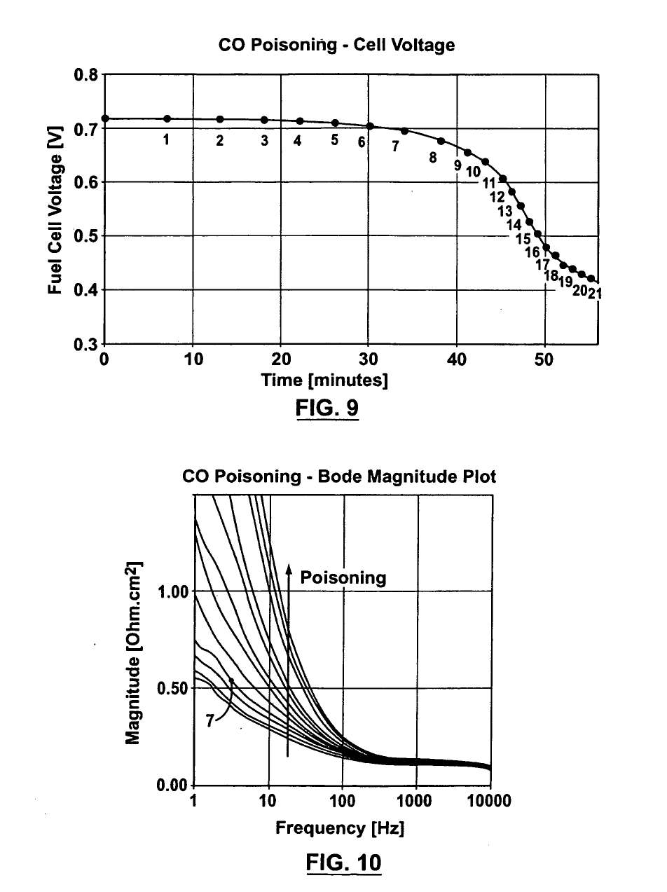

Provided for illustrative purposes only, FIGS. 9, 10 and 11 show plots of tests data related to CO-poisoning in a PEMFC stack. The PEMFC under test was operated at 400 mcm² and was subjected to 50 ppm of carbon monoxide added to the anode fuel feed. The voltage of one representative cell within the stack was monitored with respect to time as shown in FIG. 9. One of the effects of CO-poisoning is that cell voltage drops as time goes on.

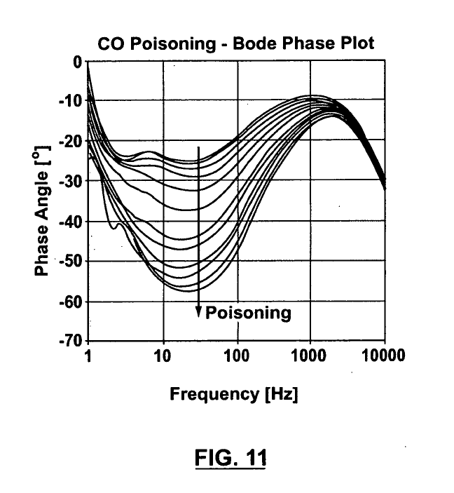

FIGS. 10 and 11 show data collected at the data points indicated in FIG. 9. Arrows on FIGS. 10 and 11 indicate the change in the magnitude and phase angle with increasing CO-poisoning level. As shown clearly in FIG. 10, the magnitude of the impedance increases with time and with the CO-poisoning level. The increases in impedance magnitude are most pronounced at lower frequencies. For example, after about 34 minutes, corresponding to point “7” on FIG. 9, the fuel cell voltage drops about 6% from its original value, whereas the fuel cell impedance magnitude increases by about 24% of its original value measured before the poisoning effect at approximately 5 Hz.

The changes in impedance phase angle are shown in FIG. 11. FIG. 11 shows the poisoning effect being more pronounced at intermediate frequencies and presenting a minimum in phase angle, i.e. more negative values, for frequencies ranging from 10 to 100 Hz. While this example shows clear data for carbon monoxide as a poison, it is expected that numerous other catalyst poisons will show similar or readily identifiable characteristics in measured impedance values.

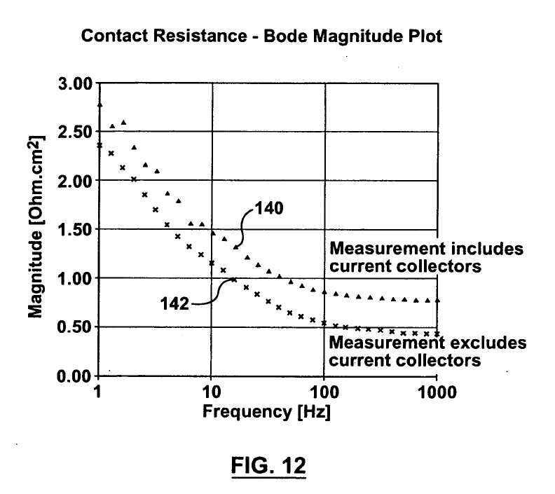

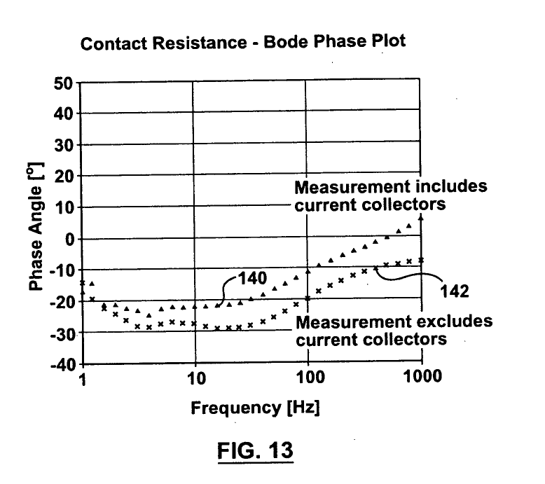

Provided as an illustrative example only, FIGS. 12 and 13 are Bode plots showing impedance magnitude and phase angle, respectively, as a function of frequency with and without the impedance contribution of the current collectors. Contact resistance between components of an electrochemical cell leads to an ohmic voltage drop during operation. In the specific case of fuel cells, this ohmic voltage drop causes ohmic heating and decreases fuel cell voltage and fuel cell efficiency. The detection of ohmic resistance may be indirectly measured by first measuring a voltage drop between components in a fuel cell stack. However, the stack needs to be operated at a high enough current level to generate an accurately measurable voltage drop.

In accordance with aspects of the present invention, as an alternative to measuring DC voltages, AC impedance can be used to measure contact resistances without requiring high currents. This technique is applicable to the detection of any contact resistance faults between any pair of components in an electrochemical cell stack, such as for example, current collectors, starter/initial flow field plates, adjacent flow field plates, and other connections. It is also possible to select two components that encompass a number of components between them, to measure the impedance of a particular section of an electrochemical cell stack (e.g. to measure the impedance between one current collector and a flow field plate in the middle of the stack). As such, in accordance with some embodiments of the invention it is possible to specifically locate a fault within an electrochemical cell stack.

Referring to FIGS. 12 and 13, these show measurement of AC impedance signature for two different cases. In one case, indicated by 140, the impedance signature includes the effects of including the impedance contribution of the current collector plates included in the fuel cell stack. In a second case, indicated by 142, the impedance signature does not include the effects of the current collector plates.

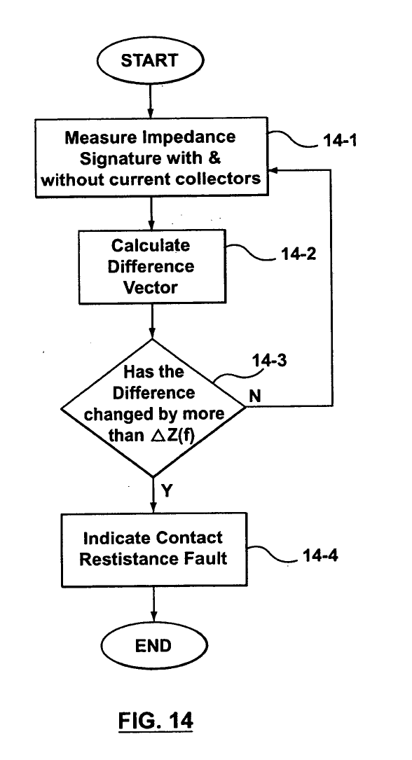

The magnitude of the measured impedance is greater when the current collectors are included, as indicated at 140. This effect is shown for a wide range of frequencies (1-1000 hertz) in FIG. 12. FIG. 13 shows a similar effect on the impedance phase angle. In accordance with some embodiments of the invention, if the difference between the two impedance magnitude measurements increases above a pre-determined value, then a fuel cell stack may be deemed defective and require repair (e.g. adjustment of clamping force or even disassembly and reassembly). This can be determined either from the magnitude, and/or the phase angle, and/or the real part and/or the imaginary part measurements. FIGS. 14, 18 and 19, described in detail below illustrates some method steps that are provided in accordance with aspects of the invention that incorporate this set of fault criteria during the monitoring of a PEMFC.

Specifically referring to FIG. 14, shown is a flow chart illustrating method steps for detecting contact resistance provided in accordance with some aspects of the invention. Beginning at step 14-1, the method of detecting contact resistance includes measuring the impedance signature with and without the impedance contribution of the current collectors. The next step, 14-2, includes calculating a difference vector representing the difference in impedance at each frequency between the measured impedance with and without the current collectors.

Subsequently at step 14-3 the difference vector is evaluated to determine if the impedance difference at one or more frequencies has changed by an impedance difference threshold ΔZ(f)—where ΔZ(f)=|Z_{REF}(f)−Z_{MEASUREMENT}(f)|—representing the maximum allowable change and/or variance in impedance permitted before a contact resistance fault is said to exist. If the impedance difference has not changed by more than the threshold amount ΔZ(f) (no path, step 14-3), then it is assumed that that a contact resistance fault does not exist and the impedance signatures can be re-measured after a short delay starting at step 14-2. On the other hand, if the impedance difference has changed by more than the threshold amount (yes path, step 14-3), then the method proceeds to step 14-4 which includes indicating that a contact resistance fault is present in the electrochemical cell module.

Additionally and/or alternatively, a contact resistance fault in an electrochemical cell is detected only when the impedance difference threshold ΔZ(f) is violated over a particular range of frequencies or over one or more ranges of frequencies by some amount (e.g. more than 5%). Moreover, in other embodiments the method described with reference to FIG. 14 may be adapted to detect a contact resistance fault between any two components in an electrochemical cell module.

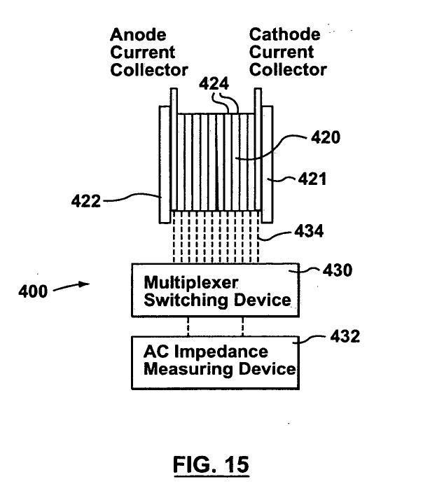

Additionally and/or alternatively, the method may be adapted and subsequently applied so as to specifically locate a contact resistance fault between two components by first identifying a portion of the electrochemical cell module where a contact resistance fault may be located and then narrowing the evaluation to specifically locate a particular fault. More generally, this technique is applicable to detecting a number of different faults, other than just contact resistance, and identifying cells and or groups of cells that are faulty. To that end, shown in FIG. 15 is a simplified schematic drawing of a multiplexer-switching system 400 for measuring AC impedance, Z(f), according to an embodiment of the invention.

The multiplexer-switching system 400 includes and AC Impedance measuring device 432 and a multiplexer switching device 430. The multiplexer-switching system 400 is illustrated in combination with fuel cell stack 420. The fuel cell stack 420 includes current collectors 421 and 422, between which a number of individual fuel cells are arranged. The fuel cells include individual flow field plates, indicated for example as 424. The multiplexer-switching system 400 also includes a number of voltage and current sensor receptors 434 connectable to individual fuel cells 124 and current collector plates 421 and 422.

Contact resistance between the fuel cell's sub-components leads to an ohmic drop when the fuel cell stack 420 produces current. This ohmic voltage drop causes ohmic heating and decreases fuel cell voltage and fuel cell efficiency. In some embodiments detection of ohmic resistance is accomplished by measuring a voltage drop between components in the fuel cell stack 420. This technique is applicable to the detection of any contact resistance faults between many pairs of components of the fuel cell stack 420, including, for example and without limitation, starter/initial flow field plates 421, 422, adjacent flow field plates 424, and other connections.

In operation, the multiplexer-switching device 430 enables a pair of components to be selected (e.g. a pair of adjacent flow field plates 424). It is also possible to select two components that encompass a number of components between them, to measure the impedance of a section of the stack (e.g. between current collector 422 and an arbitrary flow field plate 424). This could be used to narrow down a location of a fault within a stack.

Additionally and/or alternatively, a method of cycling through the different combinations of a pair of components at set intervals to monitor the condition of an electrochemical cell stack is thus enabled. During such a method, for each combination of a pair of components the impedance signature is evaluated against a reference impedance signature to determine if a fault exists and where it exits in relation to two components in an electrochemical cell stack.

Additionally and/or alternatively, in accordance with some aspects of the invention a method of detecting a contact resistance fault may be integrated into a more complex fault detection system and/or method capable of detecting a number of different types of faults. An example of such a method is described below with reference to FIGS. 18 and 19. In accordance with some aspects of the invention, a method includes cycling through individual cells in a stack. The rate or frequency with which the cycling occurs is preferably sufficiently high that a fault of concern can be detected and corrective action taken before substantial damage occurs to an individual cell or stack. For example, if the method includes checking for dehydration, then any cell with a membrane showing signs of dehydration should be detected and corrective action (e.g. raising the humidity) taken before the membrane burns or ruptures.

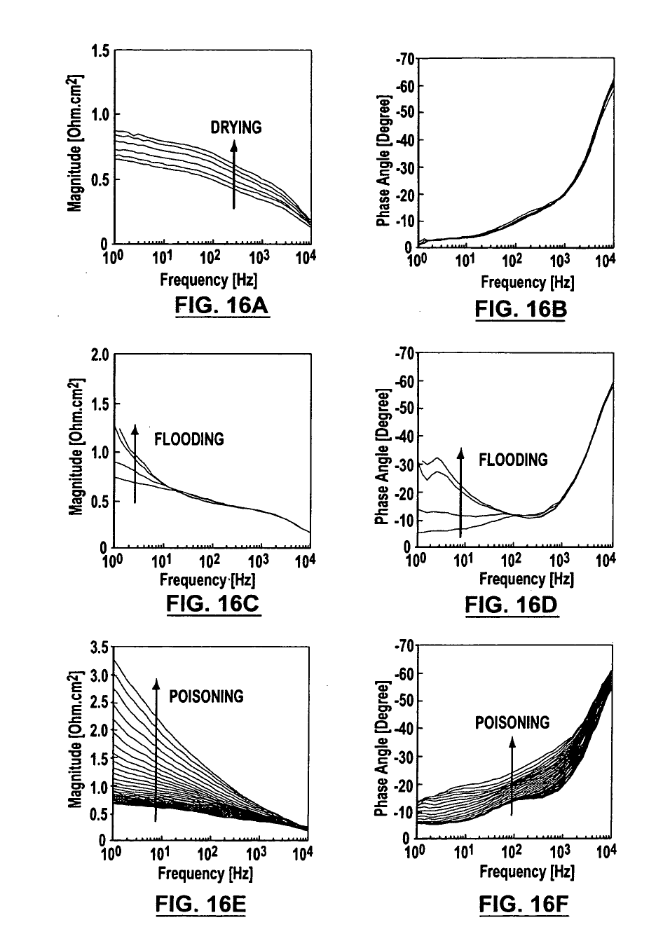

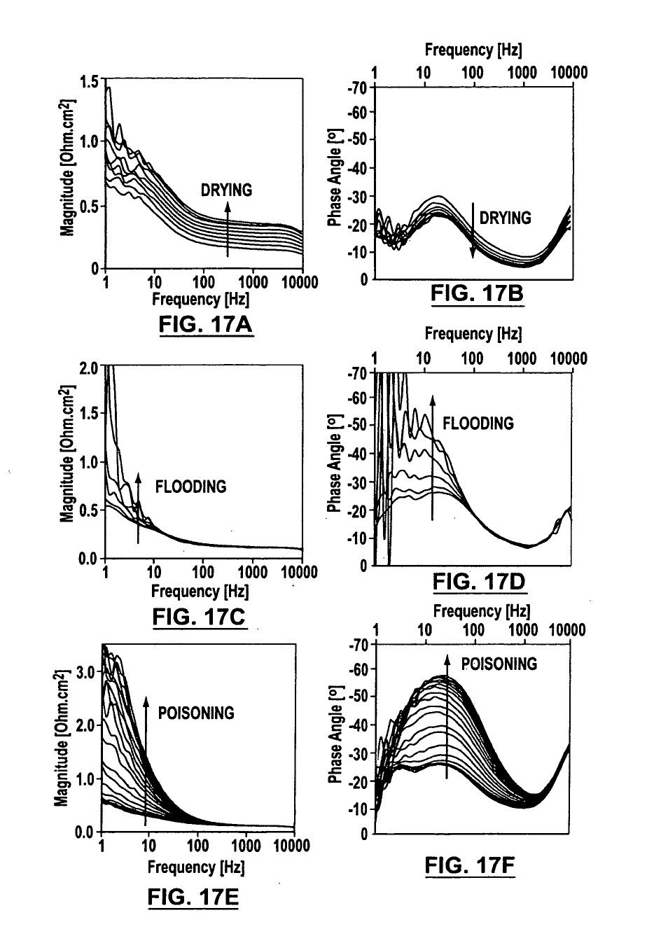

However, provided as illustrative examples to show how changes in impedance signatures can be matched to particular faults, FIGS. 16A-16F and 17A-17F show the results of controlled testing for two different fuel cell modules.

More specifically, FIGS. 16A-16F are Bode plots of EIS measurements taken from small-scale single cells (30 cm² active area). Impedance signatures were identified for membrane drying (FIGS. 16A and 16B), cell flooding (FIGS. 16C and 16D) and anode catalyst poisoning (FIGS. 15E and 15F).

FIGS. 16A and 16B are Bode plots showing changes in impedance magnitude and phase angle, respectively, as a function of dehydration (i.e. drying). As drying conditions worsen, the impedance magnitude increases in the frequency range from 1 Hz up to 10 kHz, whereas the impedance phase angle remains relatively unchanged.

FIGS. 16C and 16D are Bode plots showing changes in impedance magnitude and phase angle, respectively, as a function of flooding. As flooding conditions worsen, the impedance magnitude increases at low frequencies (f<10 to 20 Hz), and the impedance phase angle decreases at low to medium frequencies (f<100 Hz).

FIGS. 16E and 16F are Bode plots showing changes in impedance magnitude and phase angle as a function of CO-poisoning. As CO-poisoning worsens, the impedance magnitude increases and the impedance phase angle decreases across the frequency range (1 Hz to 1 kHz) observed. The increase in impedance magnitude is much more significant at low and medium frequencies (f<approx 1 kHz). Compared to drying and flooding, catalyst CO-poisoning is characterized by a decrease in impedance phase angle at moderately-high, medium and low frequencies.

Similarly, FIGS. 17A-17F are Bode plots of EIS measurements taken from large-scale production stacks (500 cm² active area). Impedance signatures were identified for membrane drying (FIGS. 17A and 17B), cell flooding (FIGS. 17C and 17D) and anode catalyst poisoning (FIGS. 17E and 17F). In comparison to the Bode plots shown in FIGS. 16A-16F, there are differences in effects caused by drying, flooding and CO-poisoning. These differences can be accounted for by the fact that different designs of electrochemical cell modules have slightly different impedance signatures. Thus, it is preferable that a fault-detection system be calibrated for the particular type of electrochemical cell stack or module that it is used in combination with.

FIGS. 17A and 17B are Bode plots showing changes in impedance magnitude and phase angle, respectively, as a function of dehydration (i.e. drying). As drying conditions worsen, the impedance magnitude increases across the entire frequency range tested from 1 Hz up to 10 kHz, and the impedance phase angle decreases over the frequency range from approximately 1 Hz and to 10 kHz.

FIGS. 17C and 17D are Bode plots showing changes in impedance magnitude and phase angle, respectively, as a function of flooding. As flooding conditions worsen, the impedance magnitude increases at low frequencies (f<10 Hz), and the impedance phase angle also decreases at low to medium frequencies (f<100 Hz).

FIGS. 17E and 17F are Bode plots showing changes in impedance magnitude and phase angle as a function of CO-poisoning. As CO-poisoning worsens, the impedance magnitude increases for frequencies below approximately 150 Hz and the impedance phase angle decreases in the frequency range between 1 Hz to 5 kHz. The increase in impedance magnitude is much more significant at low and medium frequencies (f<approx 1 kHz). Compared to drying and flooding, catalyst CO-poisoning is characterized by a decrease in impedance phase angle at moderately-high (between 1 kHz and 5 kHz), medium and low frequencies.

In accordance with aspects of the present invention, it is possible to use the effects on impedance signature caused by particular faults to derive a method of fault detection for detecting one or more faults in an electrochemical cell module. For example, using the data from FIGS. 16A to 16F it is possible to derive a set of fault criteria for evaluating the performance of a particular fuel cell module. To that end, FIG. 18 is a flow chart illustrating method steps for detecting various fault conditions within a fuel cell during operation according to a first very specific example method, in accordance with an aspect of the invention, based on the effects of drying, flooding and anode catalyst poisoning illustrated in Bode plots of FIGS. 16A-16F. Moreover, the method steps illustrated in FIG. 19 also include recovery steps to counter the effects of a particular detected fault. Similar to FIG. 18, FIG. 19 is a flow chart illustrating method steps for detecting various fault conditions within a fuel cell during operation according to a second very specific example method, in accordance with an aspect of the invention, based on the effects of drying, flooding and anode catalyst poisoning illustrated in Bode plots of FIGS. 17A-17F.

Referring first to FIG. 18, starting at step 18-1, the impedance signature Z(f) of an electrochemical cell module is measured. At step 18-2, the measured impedance signature Z(f) is compared to a reference data or a reference impedance signature defining the expected impedance signature for the current operating conditions of the electrochemical cells module (e.g. nominal operating conditions, deteriorated operating conditions, standby operating conditions, etc.).

At step 18-3 it is determined whether or not the impedance magnitude at low frequencies has changed. With additional reference to FIGS. 16A-16F, it is noted that all faults share the common characteristic of increased impedance magnitude at low frequencies. Accordingly, if the impedance magnitude has not increased at low frequencies (no path, step 18-3), then the method starts again at step 18-1. On the other hand, if the impedance magnitude has increased at low frequencies (yes path, step 18-3), then the method proceeds to step 18-4. Additionally and/or alternatively, a threshold impedance magnitude change may be specified to permit minor variances in impedance magnitude and allow for an acceptable level of degradation before a fault is detected.

At step 18-4, it is determined whether or not the impedance phase angle has changed at the low and medium frequencies. If the impedance phase angle has changed at the low and medium frequencies (yes path, step 18-4) the method proceeds to step 18-11, which is described further below. On the other hand, if the phase angle has not changed (no path, step 18-4) the method proceeds to step 18-5, where the distinction between a contact resistance fault and a drying fault is made.

The effects on impedance signatures caused by dehydration and contact resistance faults may sometimes be very similar. Thus, it is sometimes difficult to derive unique fault criteria to distinguish drying faults from contact resistance faults. At step 18-5, the status of a flag is determined. The flag serves as a check to determine if there has been an attempt to address a drying fault before indicating that there is a contact resistance fault. The reason for this is that contact resistance faults typically require shutting down an electrochemical cell with such a fault for repair and/or maintenance, which is a more drastic measure than trying to address a drying fault. If the flag is not set (no path, step 18-5), a drying fault is indicated at step 18-6, the flag is set at step 18-7, the humidity is increased at step 18-8 and the method then proceeds back to step 18-1. If the fault was indeed a drying fault the condition of step 18-3 described above will not result in a positive indication that there is a fault as given by an increase in impedance magnitude at low frequencies. However, on the other hand, if the fault is not a drying fault, the method proceeds back to step 18-5 (barring any other types of faults having developed). Accordingly, if the flag is set (yes path, step 18-5), a contact resistance fault is indicated at step 18-9, the flag is reset at step 18-10 and then the method ends prompting a shut down of the electrochemical cell module so that the contact resistance fault may be repaired.

At step 18-11, a distinction between a flooding fault and a CO-poisoning fault is made by determining whether or not the impedance phase angle at high frequencies has changed. If the impedance phase angle has not changed at high frequencies (no path, step 18-11), a flooding fault is indicated at step 18-12 and the flow stoichiometry is increased at step 18-13. After step 18-13, the method starts again at step 18-1. On the other hand, if the impedance phase angle has changed at high frequencies (yes path, step 18-11), a CO-poisoning fault is indicated at step 18-14 and an appropriate recovery action or set of actions is carried out at step 18-15.

There are a number of recovery actions that can be carried out at step 18-15. For example, if the anode output includes a controllable purge valve, the purge valve may be opened to flush out carbon monoxide accumulating in the stack. This enables purge cycles to be controlled, to prevent accumulation of carbon monoxide amounts that would cause poisoning problems, while at the same time ensuring that the amount of fuel gas vented through the purge valve is minimized. Additionally and/or alternatively, a controllable air bleed valve coupled to an anode fuel feed may be also used to introduce ambient air in the to a fuel cell to counter the effects of CO-poisoning. The introduction of air into the cell stack results in oxidation of CO to CO₂. Keeping air introduction to a minimum also reduces the damaging effect of carbon monoxide and/or oxygen on membrane electrode assemblies within the individual PEM cells. Similar approaches may also be taken to flush other poisoning substances.

Turning to FIG. 19, starting at step 19-1, the impedance signature Z(f) of an electrochemical cell module is measured. At step 19-2, the measured impedance signature Z(f) is compared to a reference data or a reference impedance signature defining the expected impedance signature for the current operating conditions of the electrochemical cells module (e.g. nominal operating conditions, deteriorated operating conditions, standby operating conditions, etc.).

At step 19-3 it is determined whether or not the impedance magnitude at low frequencies has changed. With additional reference to FIGS. 17A-17F, it is noted that all faults share the common characteristic of increased impedance magnitude at low frequencies. Accordingly, if the impedance magnitude has not increased at low frequencies (no path, step 19-3), then the method starts again at step 19-1. On the other hand, if the impedance magnitude has increased at low frequencies (yes path, step 19-3), then the method proceeds to step 19-4. Additionally and/or alternatively, a threshold impedance magnitude change may be specified to permit minor variances in impedance magnitude and allow for an acceptable level of degradation before a fault is detected.

At step 19-4, it is determined whether or not the impedance phase angle has increased or decreased at the low and medium frequencies. If the impedance phase angle has decreased at the low and medium frequencies (“D” path, step 19-4) the method proceeds to step 19-11, which is described further below. On the other hand, if the phase angle has increased (“I” path, step 19-4) the method proceeds to step 19-5, where the distinction between a contact resistance fault and a drying fault is made.

The effects on impedance signatures caused by dehydration and contact resistance faults may sometimes be very similar. Thus, it is sometimes difficult to derive unique fault criteria to distinguish drying faults from contact resistance faults. At step 19-5, the status of a flag is determined. The flag serves as a check to determine if there has been an attempt to address a drying fault before indicating that there is a contact resistance fault. The reason for this is that contact resistance faults typically require shutting down an electrochemical cell with such a fault for repair and/or maintenance, which is a more drastic measure than trying to address a drying fault. If the flag is not set (no path, step 19-5), a drying fault is indicated at step 19-6, the flag is set at step 19-7, the humidity is increased at step 19-8 and the method then proceeds back to step 19-1. If the fault was indeed a drying fault the condition of step 19-3 described above will not result in a positive indication that there is a fault as given by an increase in impedance magnitude at low frequencies. However, on the other hand, if the fault is not a drying fault, the method proceeds back to step 19-5 (barring any other types of faults having developed). Accordingly, if the flag is set (yes path, step 19-5), a contact resistance fault is indicated at step 19-9, the flag is reset at step 19-10 and then the method ends prompting a shut down of the electrochemical cell module so that the contact resistance fault may be repaired.

At step 19-11, a distinction between a flooding fault and a CO-poisoning fault is made by determining whether or not the impedance phase angle at high frequencies has changed. If the impedance phase angle has not changed at high frequencies (no path, step 19-11), a flooding fault is indicated at step 19-12 and the flow stoichiometry is increased at step 19-13. After step 19-13, the method starts again at step 19-1. On the other hand, if the impedance phase angle has changed at high frequencies (yes path, step 19-11), a CO-poisoning fault is indicated at step 19-14 and an appropriate recovery action or set of actions is carried out at step 19-15.

There are a number of recovery actions that can be carried out at step 19-15. For example, if the anode output includes a controllable purge valve, the purge valve may be opened to flush out carbon monoxide accumulating in the stack. This enables purge cycles to be controlled, to prevent accumulation of carbon monoxide amounts that would cause poisoning problems, while at the same time ensuring that the amount of fuel gas vented through the purge valve is minimized. Additionally and/or alternatively, a controllable air bleed valve coupled to an anode fuel feed can be also be used to introduce ambient air in the to a fuel cell to counter the effects of CO-poisoning. The introduction of air into the cell stack results in oxidation of CO to CO₂. Keeping air introduction to a minimum also reduces the damaging effect of carbon monoxide and/or oxygen on membrane electrode assemblies within the individual PEM cells. Similar approaches may also be taken to flush other poisoning substances.

During the design of a fuel cell, substantial testing is often performed to determine the efficiency, ease of manufacture and commercial utility of the design. During such tests, the fuel cell may be subjected to extreme conditions (environmental, load, water supply, fuel supply, oxidant supply conditions, etc.) intended to ensure that the fuel cell is capable of operating in less than ideal circumstances. The present invention may be used, periodically or between tests, to determine whether the fuel cell has developed a fault. If any fault conditions are detected, further testing may be stopped, or other appropriate action may be undertaken to repair the fuel cell or to conduct tests that will not be affected by the detected fault.

The present invention may be implemented in a control loop. For example, during testing or ongoing use of a fuel cell, the present invention may be used to continuously monitor selected impedance spectrum properties of the fuel cell in response to the load on the fuel cell. The impedance spectrum property may then be compared with known fault conditions for those properties and the testing or use of the fuel cell may be stopped to permit appropriate action to be taken. Such actions may include repairing the fuel cell, replacing it or continuing testing or use of the fuel cell in a manner that will not be affected by the detected fault.

Alternatively, the control loop may be implemented to periodically conduct a test of the fuel cell using a controlled load condition, as described above. Such testing may be done periodically when the fuel cell is not otherwise being used. The performance of such tests may be automated and the use of the fuel cell may be interrupted if a fault condition is detected.

While the above description provides example embodiments, it will be appreciated that the present invention is susceptible to modification and change without departing from the fair meaning and scope of the accompanying claims. Accordingly, what has been described is merely illustrative of the application of aspects of embodiments of the invention and numerous modifications and variations of the present invention are possible in light of the above teachings.

We claim:

1. A method of detecting a fault in an electrochemical cell module comprising:
determining operating characteristics of the electrochemical cell module for at least one discrete frequency to obtain a measured impedance value;
providing a reference impedance value and a fault criterion based on a deviation from the reference impedance value; and
comparing the measured impedance value with a reference impedance value to determine whether or not the fault criterion has been satisfied.

2. A method according to claim 1, further comprising providing an indication that a corresponding fault has been detected if the at least one fault criterion has been satisfied when the measured impedance value is compared with the reference impedance value.

3. A method according to claim 1, wherein determining operating characteristics of an electrochemical cell module includes measuring at least one of the Alternating Current (AC) voltage across electrical terminals of the electrochemical cell module and AC current through the electrochemical cell module.

4. A method according to claim 1, wherein the at least one fault criterion includes at least one threshold value relating one of: respective magnitudes of the measured and reference impedance values; respective phase angles of the measured and reference impedance values; respective real portions of the measured and reference impedance values; and, respective imaginary parts of the measured and reference impedance values.

5. A method according to claim 1, wherein comparing the measured impedance value with the reference impedance value includes calculating a ratio between the measured impedance value and the reference impedance value.

6. A method according to claim 1, wherein comparing the measured impedance value with the reference impedance value includes calculating a ratio between the magnitude of the measured impedance value and the magnitude of reference impedance value.

7. A method according to claim 1, wherein comparing the measured impedance value with the reference impedance value includes calculating a ratio between the phase angle of the measured impedance value and the phase angle of reference impedance value.

8. A method according to claim 1, wherein comparing the measured impedance value with the reference impedance value includes calculating a difference between the measured impedance value and the reference impedance value.

9. A method according to claim 1, wherein comparing the measured impedance value with the reference impedance value includes calculating a difference between the magnitude of the measured impedance value and the magnitude of reference impedance value.

10. A method according to claim 1, wherein comparing the measured impedance value with the reference impedance value includes calculating a difference between the phase angle of the measured impedance value and the phase angle of reference impedance value.

11. A method according to claim 1, wherein the reference impedance value is one of a plurality of reference impedance values included in a reference impedance signature for the electrochemical cell module, wherein each of the reference impedance values corresponds to a respective discrete frequency.

12. A method according to claim 11, wherein the reference impedance signature is at least partially dependent on a specific set of operating conditions for the electrochemical cell module.

13. A method according to claim 11, further comprising:
determining operating characteristics of the electrochemical cell module for a plurality of discrete frequencies to obtain a measured impedance signature including a corresponding plurality of frequency dependent impedance values; and
comparing at least one characteristic of the measured impedance signature with a corresponding at least one characteristic of a reference impedance signature and the at least one fault criterion to determine whether or not the fault criterion has been met.

14. A method according to claim 1, further comprising adjusting at least one operating parameter of the electrochemical cell module to compensate for a detected fault.

15. A method according to claim 14, wherein if the fault detected is a result of flooding, adjusting at least one operating parameter includes increasing flow stoichiometry.

16. A method according to claim 14, wherein if the fault detected is a result of dehydration, adjusting at least one operating parameter includes increasing humidity within the electrochemical cell module.

17. A method according to claim 14, wherein if the fault detected is a result of poisoning, adjusting at least one operating parameter includes flushing a portion of the electrochemical cell module to remove, dilute and/or chemically change the poisoning substance.

18. A method according to claim 14, wherein if the fault detected is a result of carbon monoxide (CO) poisoning, adjusting at least one operating parameter includes introducing air into a portion of the electrochemical cell module to remove, dilute and/or chemically change the CO into carbon dioxide (CO₂).

19. A method according to claim 14, wherein if the fault detected is a result of a change in contact resistance, adjusting at least one operating parameter controllably shutting down the electrochemical cell module to repair the contact resistance fault.

20. A method of detecting a fault in an electrochemical cell module comprising:
characterizing an electrochemical cell module to obtain a reference impedance signature, wherein the reference impedance signature includes a plurality of reference impedance values for a corresponding set of discrete frequency values;
obtaining at least one measured impedance signature during the intended use of an electrochemical cell module;
providing a fault criterion based on a deviation from the reference impedance value; and
comparing at least one characteristic of the reference impedance signature with the at least one characteristic of the at least one measured impedance signature to determine whether or not a fault exists in the electrochemical cell module.

21. A method according to claim 20, wherein characterizing the electrochemical cell module and obtaining a measured impedance signature from an electrochemical cell module includes imposing an Alternating Current (AC) voltage or AC current on the Direct Current (DC) voltage or DC current, respectively, wherein the DC voltage and DC current are the result of a specific set of operating parameters defining a mode of use for the electrochemical cell module.

22. A system for detecting a fault in an electrochemical cell module comprising:
at least one sensor connectable to an electrochemical cell module for monitoring at least one operating parameter of the electrochemical cell module; and
a computer program product including a computer usable program code for determining whether or not at least one fault criterion has been satisfied and thereby indicating the presence of a fault in an electrochemical cell module, the computer usable program code including program instructions for: determining operating characteristics of the electrochemical cell module for at least one discrete frequency to obtain a measured impedance value; providing a reference impedance value and a fault criterion based on a deviation from the reference impedance value; and, comparing the measured impedance value with a reference impedance value and at least one fault criterion to determine whether or not the fault criterion has been satisfied.

23. A system according to claim 22, wherein the computer usable program code further comprises program instructions for measuring the Alternating Current (AC) voltage across electrical terminals of the electrochemical cell module and AC current through the electrochemical cell module and calculating the measured impedance value.

24. A system according to claim 22, wherein the computer usable program code further comprises program instructions for calculating at least one of:a ratio between the measured impedance value and the reference impedance value; a ratio between the magnitude of the measured impedance value and the magnitude of reference impedance value; a ratio between the phase angle of the measured impedance value and the phase angle of reference impedance value; a difference between the measured impedance value and the reference impedance value; a difference between the magnitude of the measured impedance value and the magnitude of reference impedance value; and, a difference between the phase angle of the measured impedance value and the phase angle of reference impedance value.

25. A system according to claim 22, wherein the computer usable program code further comprises program instructions for adjusting at least one operating parameter of the electrochemical cell module to compensate for a detected fault.

26. A system for detecting a fault in an electrochemical cell module comprising:
at least one sensor connectable to an electrochemical cell module for monitoring at least one operating parameter of the electrochemical cell module; and
a computer program product including a computer usable program code for determining whether or not at least one fault criterion has been satisfied and thereby indicating the presence of a fault in an electrochemical cell module, the computer usable program code including program instructions for: characterizing an electrochemical cell module to obtain a reference impedance signature, wherein the reference impedance signature includes a plurality of reference impedance values for a corresponding set of discrete frequency values; obtaining at least one measured impedance signature during the intended use of an electrochemical cell module; providing a fault criterion based on a deviation from the reference impedance value; and, comparing at least one characteristic of the reference impedance signature with the at least one characteristic of the at least one measured impedance signature to determine whether or not the fault criterion has been satisfied.

27. A system for detecting a fault in an electrochemical cell module comprising:
a sensor means for monitoring at least one operating parameter of the electrochemical cell module;
a means for establishing fault criteria based on deviations from reference impedance information;
a processor means for determining operating characteristics of the electrochemical cell module for at least one discrete frequency to obtain a measured impedance value; and
a comparison means for determining whether or not at least one fault criterion has been satisfied and thereby indicating the presence of a fault in an electrochemical cell module, the comparison means comparing the measured impedance value with a reference impedance value to determine whether or not the fault criterion has been satisfied.
